(19) United States
(12) Patent Application Publication
(10) Pub. No.: US 2025/0185852 A1
(43) Pub. Date: Jun. 12, 2025

(54) LID LIFTER

(71) Applicant: HBS Hotel & Bau Swiss GmbH, Kloten (CH)

(72) Inventor: Heval Tasan, Berlin (DE)

(73) Assignee: HBS Hotel & Bau Swiss GmbH, Kloten (CH)

(21) Appl. No.: 18/533,159

(22) Filed: Dec. 7, 2023

(51) Int. Cl. A47J 45/10; A47J 33/00

(52) U.S. Cl. CPC A47J 45/10; A47J 33/00

(57) ABSTRACT

Lid lifter for a lid of a Dutch Oven, comprising a handle, a hook arranged at one end of the handle for lifting the lid, and a screw arranged at the opposite end of the handle for screwing the lid lifter onto the lid.

### FIELD OF THE INVENTION

The invention relates to a lid lifter for a Dutch oven lid, comprising a handle and a hook arranged at an end portion of the handle for lifting the lid.

### BACKGROUND

In the case of a Dutch Oven, it concerns a cast-iron pot with lid, which is intended for direct use in a heat source, for example, in a campfire.

In general, a Dutch Oven has small feet below the pot. Also, on the lid, such feet can be provided in some cases.

These allow the user to place coals below the pot or lid, thus enabling even better regulation of the heat supply.

Since the entire pot as well as the lid are preferably made of cast iron, and this material absorbs heat very well while also retaining it for a long period, the hot pot cannot be easily opened or the lid removed with bare hands.

For this reason, a so-called lid lifter is used. This is a handle with a small hook on one side.

This allows the user to lift the lid. For this purpose, the hook of the lid lifter must be passed through a small loop on the lid.

Subsequently, the lid can be lifted using the lid lifter.

The disadvantage is that the lid lifter is only used for lifting the lid. The functionality is thereby limited.

Therefore, it is an object of the invention to create a lid lifter, a system with a lid lifter and a lid, as well as a Dutch Oven that can be used multifunctionally.

The solution to this problem is provided by the objects of the independent claims.

### BRIEF SUMMARY OF THE INVENTION

According to the invention, the lid lifter is suitable for a Dutch Oven lid and/or can be used for this purpose.

The lid lifter has a handle.

At one end of the handle, a hook is arranged for lifting the lid. The hook is preferably bent.

The hook, for example, can be inserted into a loop on the lid. The lid can be lifted by the loop.

This is a common function of the lid lifter.

Preferably, a support can be provided on the hook. The support, for example, can be oriented perpendicular to the handle. When the hook is inserted into the loop, the support can rest against the lid. This allows for controlled lifting of the lid.

The lid lifter has a screw arranged at an opposite end of the handle for screwing the lid lifter onto the lid.

The screw, for example, can be screwed into a thread on the lid, which is preferably placed there solely for this purpose.

In conventional lid lifters, only the end of the handle is located at this end, preventing attachment to the lid.

When the handle is screwed onto the lid, the lid can be used as a pan. The lid lifter then serves as the handle for the pan.

Therefore, the lid lifter is multifunctional and has a 2-in-1 function. In comparison to a conventional lid lifter, the inventive lid lifter allows the user to use, for example, a hot lid as a fully functional pan

Thanks to the screw on the side of the handle, the lid lifter provides the user with improved handling of the Dutch Oven and allows the use of the lid as a fully functional pan.

Further developments of the invention can also be found in the dependent claims, the description, and the accompanying drawings.

According to one embodiment, the handle is rod-shaped

The handle, which can be referred to as a holding rod, can thus be securely and/or comfortably held by a user.

The length of the handle is generally arbitrary and can, for example, be between 10 cm and 50 cm, preferably between 15 cm and 30 cm.

According to another embodiment, the handle comprises or is made of wood.

Wood is sustainable on the one hand. On the other hand, wood is a poor conductor of heat, allowing the handle to be safely gripped.

According to another embodiment, the hook and/or the screw comprises or is made of a metal material, preferably (stainless) steel and/or iron.

The hook and/or the screw are therefore extremely sturdy and/or durable.

The invention also relates to the use of the lid lifter according to the invention, optionally for lifting the lid and as a handle for a lid used as a pan.

The 2-in-1 lid lifter, which features a hook on one side for lifting the hot lid and a screw on the other side that can be screwed into a thread on the lid, can serve both for lifting the lid and as a handle for the lid.

The invention relates to a system comprising a lid lifter according to the invention and a lid.

When the lid lifter is screwed onto the lid, the lid can be used as a pan.

The lid can be round, oval, or square, for example, rectangular. According to one embodiment, the lid has a loop for the hook.

The loop can be formed as a metal loop, for example, made of cast iron.

Preferably, the loop is provided on an upper side of the lid or on an underside of the pan.

On the upper side of the lid or on the underside of the pan, feet can also be provided. Despite the loop, these feet allow for a stable position of the pan.

According to another embodiment, the lid has a thread, preferably internal thread, for the screw.

The internal thread is preferably arranged on the outer circumference of the lid.

The invention relates to a Dutch Oven with a system according to the invention and a pot.

The lid can be removed from the pot using the lid lifter and used as a pan.

Finally, the invention relates to a method for selectively lifting a lid and attaching a handle to a lid used as a pan with a lid lifter according to the invention, a system according to the invention, and/or a Dutch Oven according to the invention.

In this process, the hook is guided into a loop on the lid, and the lid is lifted. Furthermore, the lid lifter can be screwed onto the lid via the screw and thus form a handle for the lid, which can be used as a pan in this way.

All embodiments and components of the devices described here are preferably designed to be assembled according to the procedure described here. Furthermore, all embodiments of the devices and all embodiments of the procedure described here can be combined with each other, preferably also independent of the specific design in which they are mentioned.

### BRIEF DESCRIPTION OF THE DRAWINGS

The invention is described below by way of example with reference to the drawings. They show:

FIG. 1 a perspective view of an embodiment of a lid lifter according to the invention,

FIG. 2 a perspective view of another embodiment of a lid lifter according to the invention,

FIG. 3 a perspective view of an embodiment of a Dutch Oven according to the invention, and

FIG. 4 a perspective view of an embodiment of a system according to the invention.

Firstly, it should be noted that the illustrated embodiments are purely exemplary in nature. Thus, individual features can be realized not only in the shown combination but also individually or in other technically meaningful combinations. For example, the features of one embodiment can be combined arbitrarily with features of another embodiment.

### DETAILED DESCRIPTION

If a figure contains a reference sign that is not explained in the immediately associated description text, reference is made to the corresponding preceding or subsequent explanations in the figure description. The same reference signs are used for identical or comparable components in the figures, and they are not explained again.

FIG. 1 shows a lid lifter 10 for a lid 12 of a Dutch Oven 14 with a handle 16.

At one end of the handle 16, a hook 18 is arranged for lifting the lid 12

Optionally, a support 20 can be provided on the hook 18. The support 20 can be oriented perpendicular to the handle 16.

At the opposite end of the handle 16, a screw 22 is provided for screwing the lid lifter 10 onto the lid 12

The handle 16 can have a round cross-sectional area.

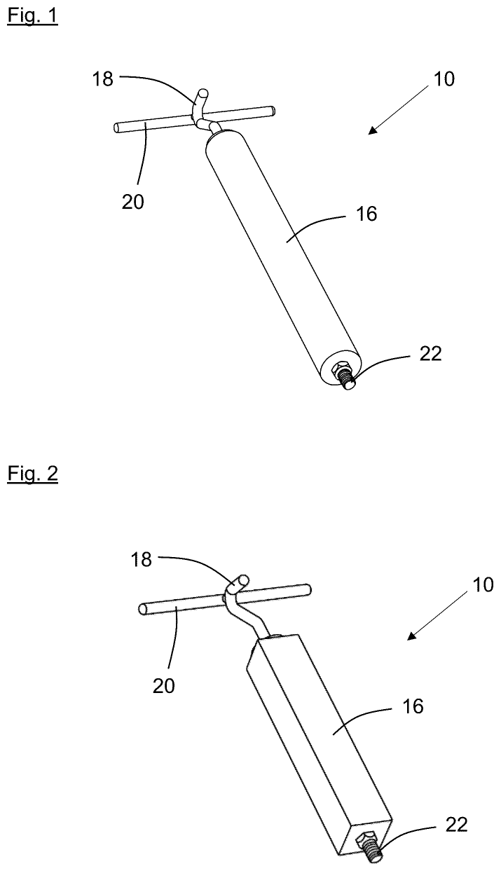

Alternatively, the handle 16 can, for example, as shown in FIG. 2, have a rectangular cross-sectional area. Other shapes, such as triangular, pentagonal, hexagonal, heptagonal, octagonal, oval, etc., are also conceivable.

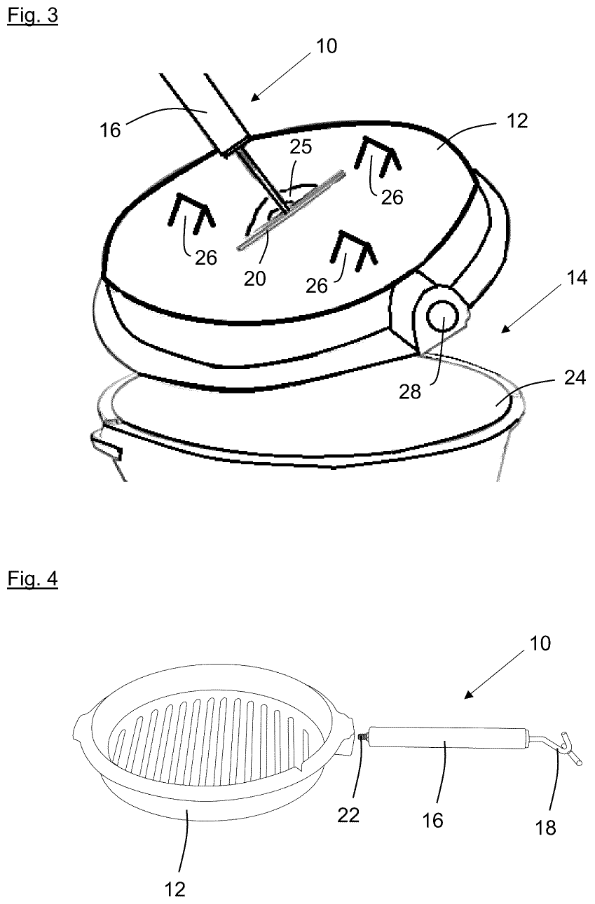

FIG. 3 shows a Dutch Oven 14 with a pot 24 and a lid 12. The lid 12 has a loop 25 in which the hook 18 of the lid lifter 10 can be inserted to lift the lid 12 from the pot 24. The support 20 rests on the lid 12, providing a secure hold.

So that the lid 12, which can be used as a pan, can be placed flat, the lid 12 can optionally have feet 26.

Furthermore, the lid 12 can have a thread 28 on its outer circumference. Into this thread 28, as seen in FIG. 4, the screw 22 of the lid lifter 10 can be screwed to be able to use the lid 12 as a pan.

### List of Reference Symbols

| | |
|---|---|
| 10 | Lid lifter |
| 12 | Lid |
| 14 | Dutch Oven |
| 16 | Handle |
| 18 | Hook |
| 20 | Support |
| 22 | Screw |
| 24 | Pot |
| 25 | Loop |
| 26 | Stand foot |
| 28 | Thread |

1. Lid lifter (10) for a lid (12) of a Dutch Oven (14), comprising
a handle (16),
a hook (18) arranged at one end of the handle (16) for lifting the lid (12), and
a screw (22) arranged at the opposite end of the handle (16) for screwing the lid lifter (10) onto the lid (12).

2. Lid lifter (10) according to claim 1,
characterized in that
the handle (16) is rod-shaped.

3. Lid lifter (10) according to claim 1,
characterized in that
the handle (16) comprises a wooden material or is made of a wooden material.

4. Lid lifter (10) according to claim 1,
characterized in that
the hook (18) and/or the screw (22) comprises a metallic material or is made of a metallic material.

5. Use of the lid lifter (10) according to claim 1, optionally for lifting the lid (12) as well as for use as a handle of a lid (12) used as a pan.

6. System with a lid (12) of a Dutch Oven (14) and a lid lifter (10), wherein the lid lifter (10) comprises
a handle (16),
a hook (18) arranged at one end of the handle (16) for lifting the lid (12), and
a screw (22) arranged at the opposite end of the handle (16) for screwing the lid lifter (10) onto the lid (12).

7. System according to claim 6,
characterized in that
the lid (12) has a loop (25) for the hook (18).

8. System according to claim 6,
characterized in that
the lid (12) has a thread (28) for the screw (22).
